(19) United States
(12) Patent Application Publication
(10) Pub. No.: US 2014/0278666 A1
(43) Pub. Date: Sep. 18, 2014

(54) ENHANCED CALENDAR VIEWS WITH EVENT PEEKS

(71) Applicant: Microsoft Corporation, Redmond, WA (US)

(72) Inventors: Jason A. Cook, Renton, WA (US); Paul David Tischhauser, Redmond, WA (US); Neel K. Joshi, Bellevue, WA (US); Christina Ryan Ergonis, Bellevue, WA (US); Karl-Erik Bystrom, Bellevue, WA (US)

(21) Appl. No.: 13/910,689

(22) Filed: Jun. 5, 2013

Related U.S. Application Data
(60) Provisional application No. 61/777,078, filed on Mar. 12, 2013.

(51) Int. Cl. G06Q 10/10

(52) U.S. Cl. CPC G06Q 10/1093
USPC 705/7.18

(57) ABSTRACT

Systems, methods, and software are disclosed herein for facilitating enhanced calendar views. In at least one implementation, a method comprises presenting a perspective on a calendar comprising a plurality of calendar units and a plurality of events scheduled in association with the plurality of calendar units. The method further comprises, in response to a primary indication of interest associated with a specific event of the plurality of events, presenting a primary perspective on the specific event comprising event details for the specific event and a plurality of event controls. The method further comprises, in response to a secondary indication of interest associated the specific event of the plurality of events, presenting a secondary perspective on the specific event comprising at least a portion of the event details and a subset of the plurality of event controls.

### RELATED APPLICATIONS

This application claims the benefit of and priority to U.S. Provisional Patent Application No. 61/777,078, filed on Mar. 12, 2013 and entitled ENHANCED CALENDAR VIEWS WITH EVENT PEEKS, which is hereby incorporated by reference in its entirety.

### TECHNICAL FIELD

Aspects of the disclosure are related to computing hardware and software technology, and in particular, to information management applications.

### TECHNICAL BACKGROUND

Information management applications provide users with effective and convenient ways to communicate with others and manage their information. Examples of information management applications include but are not limited to email applications and calendar applications. Some information management applications integrate these various types of applications by way of modules, such as email, calendar, contact, and task modules, although each type of application or functionality may also be provided in a stand-alone manner. Microsoft® Outlook® is one example of an information management application.

While many information management applications are provided as locally installed and executed applications, many can be experienced in a wide variety of ways. Some information management applications are available as web-based applications that are experienced through a browser application, as mobile applications customized for mobile environment, or even as a mobile web-based application generally developed for a mobile browser experience. In addition, information management applications can be experienced on a wide variety of computing devices, such as desktop, laptop, or tablet computers, mobile phones, gaming systems, Internet appliances, or any other physical or virtual computing system, variation, or combination thereof.

In a typical calendar application or module, a variety of perspectives on a calendar can be viewed. For example, a monthly perspective, a weekly perspective, a work-week perspective, or a daily perspective may be selected and viewed. The selected perspective typically encompasses a dominant portion of a calendar view.

A user may interact with an event once it is scheduled. For example, a user may want to accept, reject, or cancel an event, as well as modify its details or add participants to the event. Typically, an event is opened in an event view that includes various features and functions with which a user may interact. In an example, an event view may include buttons and other associated graphics corresponding to various features accessible through the event view, such as cancel, accept, and reject features, as well as an add attendee feature and details feature, or any other features.

### OVERVIEW

Provided herein are systems, methods, and software for facilitating enhanced calendar views. In at least one implementation, a method comprises presenting a perspective on a calendar comprising a plurality of calendar units and a plurality of events scheduled in association with the plurality of calendar units. The method further comprises, in response to a primary indication of interest associated with a specific event of the plurality of events, presenting a primary perspective on the specific event comprising event details for the specific event and a plurality of event controls. The method further comprises, in response to a secondary indication of interest associated the specific event of the plurality of events, presenting a secondary perspective on the specific event comprising at least a portion of the event details and a subset of the plurality of event controls.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a view of an information management application and an operational scenario in an implementation.

FIG. 2 illustrates an enhanced view process in an implementation.

FIG. 3 illustrates a computing architecture in an implementation.

FIG. 4 illustrates a communication environment in an implementation.

FIG. 5 illustrates various scenarios involving a view of an information management application in various implementations.

FIG. 6 illustrates various scenarios involving a view of an information management application in various implementations.

FIG. 7 illustrates various scenarios involving a view of an information management application in various implementations.

FIG. 8 illustrates a scenario involving a view of an information management application in an implementation.

FIG. 9 illustrates a scenario involving a view of an information management application in an implementation.

### TECHNICAL DISCLOSURE

Implementations disclosed herein facilitate improved information management applications. In at least one implementation, an enhanced calendar view includes a perspective on a calendar. The calendar perspective includes various calendar units, such as days within a month, weeks within a month, days within a week, hours within a day, or the like. The calendar perspective also includes events scheduled in association with the calendar units. For example, a meeting or other event may be scheduled on a particular day at a particular time, and so on.

Any of the events may be experienced in at least two ways. In response to a primary indication of interest associated with a specific event, a primary perspective on the specific event can be presented. The primary perspective can include event details for the specific event and associated event controls. Examples of event controls include but are not limited to controls for accepting, canceling, or modifying an event, adding participants to an event, changing details of an event, and any other type of event control. A user can interact with the primary view to engage with the event controls.

A second way in which an event may be experienced is through a secondary event perspective. The secondary event perspective may be presented in response to a secondary indication of interest. In some scenarios the primary and secondary indications of interest may differ. For example, the indications of interest may differ based on where on a representation of an event they are made. An event may have different controls, each one applying to a different type of indication of interest. In another example, different behaviors may be associated with the different indications of interest. For example, a double click or double tap on an event may trigger the primary perspective, while a single click, a right-click, or a single tap on an event may trigger the secondary perspective. More generally, a secondary indication of interest may be a single instance of an action made with respect to the specific event while a primary indication of interest may be a double instance of the action made with respect to the specific event. In another example, a hover action with a mouse or other indicator may trigger the secondary perspective.

In some scenarios, the secondary perspective may include at least a portion of the event details and a subset of the event controls. For example, the secondary perspective may include some, but not all, of the event controls included in the primary perspective.

In some implementations the secondary perspective may be considered an “event peek” that provides a user with a quick view into an event and some limited controls that give the user quick access to the event and control with respect to the event. However, to gain full access to the event and all of its associated controls, a user provides a primary indication of interest rather than a secondary indication of interest. In some scenarios the primary perspective is an event view as discussed above with respect to the background.

In at least one implementation, program instructions stored on a computer readable storage media, when executed by a processing system, direct the processing system to at least initiate presentation of a monthly perspective of a calendar having various days and various events scheduled in association with the days. In response to an indication of interest associated a specific event of the plurality of events, the processing system initiates presentation of a peek on the specific event that includes at least a portion of the event details and a subset of various event controls associated with the specific event.

In some implementations, the program instructions instruct the processing system to identify which of the plurality of controls to include in the peek based at least on a user perspective associated with the indication of interest. In addition, in some implementations the program instructions may direct the processing system to initiate an expansion of the peek to at least another specific event in response to an expansion gesture. The program instructions may also direct the processing system to initiate a substitution of a specific event in a peek with another specific event in response to a swipe gesture.

Referring now to the drawings, FIG. 1 illustrates an enhanced calendar view 100 of an information management application and an operational scenario associated with an enhanced view process 200 illustrated in FIG. 2. FIG. 3 illustrates a computing architecture suitable for any computing system or systems that may employ the enhanced view process 200 of FIG. 2. FIG. 4 illustrates a communication environment in which an information management application and associated services may be deployed. FIGS. 5-9 illustrate various views and associated operational scenarios related to various features and functionality that may be provided by an information management application.

Turning to FIG. 1, enhanced calendar view 100 is illustrated in an implementation. FIG. 1 also illustrates an operational scenario that may occur when the information management application implements or is otherwise subject to enhanced view process 200 illustrated in FIG. 2. The following discussion of FIG. 1 therefore makes parenthetical reference to the various steps included in enhanced view process 200.

Initially, enhanced calendar view 100 is presented, including a calendar perspective having various calendar units (step 201). Enhanced calendar view 100 includes information bar 101, calendar module 103, and calendar perspective 105. In this implementation, calendar perspective 105 is a weekly perspective and includes a scheduled event 107. The information management application, of which enhanced calendar view 100 provides one representation, may be any application or collection of applications, module or collection of modules, service or services, or any variation or combination thereof capable of providing information management services and functionality. Examples of the information management application include Microsoft® Outlook®, Outlook® Web App, Mobile Outlook®, Hotmail®, Outlook.com, and Gmail, as well as any other information management application. View 100 may include additional features and some of the features may be omitted. In addition, view 100 is provided merely for illustrative purposes and not to limit the scope of the present disclosure.

The information management application may include one or more information modules, of which calendar module 103 is representative. Calendar module 103 may be any component or other aspect of the information management application with which a user interacts to gain access to at least some of the various calendaring functions and services provided by the information management application, such as the ability to schedule events, invite others to participate in events, and the like. Other example modules include email modules, task modules, and contact modules, as well as any other type of module, combination, or variation thereof.

In operation, monitoring is performed for an indication of interest 109 made with respect to the scheduled event 107 (step 203). The indication of interest 109 may be at least a primary or a secondary indication of interest. In response to the indication of interest 109, either a primary or a secondary perspective on the scheduled event 107 is presented (step 205).

In this implementation, it is assumed for exemplary purposes that the indication of interest 109 is a secondary indication of interest. According, event perspective 111 is presented in an overlaid manner with respect to calendar perspective 105. Event perspective 111 includes control 113, control 115, and control 117, through which a user may interact with the scheduled event. Examples include the ability to cancel, accept an invitation, or the like. It may be appreciated that the controls surfaced by event perspective 111 are a subset of the controls that might otherwise be available through a primary perspective or event view.

It may be appreciated that, while the discussion of enhanced view process 200 illustrated in FIG. 2 generally refers to specific steps, such as presenting a calendar perspective, presenting a primary event perspective, or presenting a secondary event perspective, variations of the process are possible and may be considered within the scope of the present disclosure. Taking the step of initiating any of the aforementioned steps, as opposed to fully carrying them out, may be considered a variation. Thus, initiating presentation of any of the various perspectives may be considered a variation on the specific steps illustrated in FIG. 2.

The term presenting as used herein generally refers to the various capabilities employed in various computing architectures to assemble information that can then be used by other capabilities to generate an image or images. Within the context of enhanced view process 200, for example, presenting an enhanced calendar view or making any modifications thereof may generally refer to assembling the information or data used to generate an image or images that together result in those features.

However, it may be appreciated that other perspectives on presenting may be considered within the scope of the present disclosure. For example, presenting as used herein may also, in some scenarios, be considered to refer to the various capabilities employed by various computing architectures to generate an image or images from information assembled for that purpose. With respect to enhanced view process 200, presenting an enhanced view or making a modification to it, or an effect with respect to it, may refer to generating an image or images, from information assembled for that purpose, that together result in those features.

It may also be appreciated that presenting in some scenarios may refer to a combination of the aforementioned possibilities. For example, presenting in some scenarios may refer to both assembling the information used to generate an image or images for a feature and then generating the image or images for the feature. In addition, a wide variety of other steps, processes, and stages may occur within the context of presenting features of an application, such as driving the display of, or even actually displaying, images or other representations of a feature, all of which may be considered part of presenting a feature.

Referring now to FIG. 3, computing architecture 300 is representative of an architecture that may be employed in any apparatus, system, or device, or collections thereof, to suitably implement all or portions of enhanced view process 200 illustrated in FIG. 2 or variations thereof and optionally all or portions of the information management application referred to with respect to FIG. 1. Enhanced view process 200 may be implemented on a single apparatus, system, or device or may be implemented in a distributed manner. The information management application may also be implemented on a single apparatus, system, or device or may be implemented in a distributed manner. Enhanced view process 200 may be integrated with the information management application, but may also stand alone or be embodied in some other application.

Computing architecture 300 may be employed in, for example, desktop computers, laptop computers, tablet computers, notebook computers, mobile computing devices, cell phones, media devices, and gaming devices, as well as any other type of physical or virtual computing machine and any combination or variation thereof. Computing architecture 300 may also be employed in, for example, server computers, cloud computing platforms, data centers, any physical or virtual computing machine, and any variation or combination thereof.

Computing architecture 300 includes processing system 301, storage system 303, software 305, communication interface system 307, and user interface system 309. Processing system 301 is operatively coupled with storage system 303, communication interface system 307, and user interface system 309. Processing system 301 loads and executes software 305 from storage system 303. When executed by processing system 301, software 305 directs processing system 301 to operate as described herein for enhanced view process 200 or its variations. Computing architecture 300 may optionally include additional devices, features, or functionality not discussed here for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations, or variation.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal.

In addition to storage media, in some implementations storage system 303 may also include communication media over which software 305 may be communicated internally or externally. Storage system 303 may be implemented as a single storage device but may also be implemented across multiple storage devices or sub-systems co-located or distributed relative to each other. Storage system 303 may comprise additional elements, such as a controller, capable of communicating with processing system 301 or possibly other systems.

Software 305 may be implemented in program instructions and among other functions may, when executed by processing system 301, direct processing system 301 to operate as described herein for enhanced view process 200 illustrated in FIG. 2. In particular, the program instructions may include various components or modules that cooperate or otherwise interact to carry out enhanced view process 200. The various components or modules may be embodied in compiled or interpreted instructions or in some other variation or combination or instructions. The various components or modules may be executed in a synchronous or asynchronous manner, in a serial manner or in parallel, in a single threaded environment or multi-threaded, or in accordance with any other suitable execution paradigm, variation, or combination thereof. Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform a suitable apparatus, system, or device employing computing architecture 300 overall from a general-purpose computing system into a special-purpose computing system customized to facilitate enhanced calendar views as described herein for each implementation. Indeed, encoding software 305 on storage system 303 may transform the physical structure of storage system 303. The specific transformation of the physical structure may depend on various factors in different implementations of this description. Examples of such factors may include, but are not limited to the technology used to implement the storage media of storage system 303 and whether the computer-storage media are characterized as primary or secondary storage, as well as other factors.

For example, if the computer-storage media are implemented as semiconductor-based memory, software 305 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing architecture 300 is generally intended to represent an architecture on which software 305 may be deployed and executed in order to implement enhanced view process 200 (or variations thereof) and optionally all or portions of an information management application. However, computing architecture 300 may also be suitable for any computing system on which software 305 may be staged and from where software 305 may be distributed, transported, downloaded, or otherwise provided to yet another computing system for deployment and execution, or yet additional distribution.

Referring again to FIG. 1, through the operation of a suitable computing system employing software 305, transformations may be performed with respect to enhanced calendar view 100. As an example, enhanced calendar view 100 could be considered transformed from one state to another when subject to enhanced view process 200. In a first state, the computing system presents enhanced calendar view 100 with calendar perspective 105. Responsive to an indication of interest 109, a secondary event perspective is presented, thereby changing enhanced calendar view 100 to a second, different state.

Referring again to FIG. 3, communication interface system 307 may include communication connections and devices that allow for communication with other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface system 309 may include a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 309. In some cases, the input and output devices may be combined in a single device, such as a display capable of displaying images and receiving touch gestures. The aforementioned user input and output devices are well known in the art and need not be discussed at length here. User interface system 309 may also include associated user interface software executable by processing system 301 in support of the various user input and output devices discussed above. Separately or in conjunction with each other and other hardware and software elements, the user interface software and devices may support a graphical user interface, a natural user interface, or the like.

FIG. 4 illustrates a communication environment 400 in which various information management applications may be supported to implement enhanced calendar views and their associated operations, such as enhanced calendar view 100 discussed with respect to FIG. 1. Communication environment 400 includes application platform 401, application platform 403, and application platform 405. Application platform 401 and application platform 403 may communicate with service environment 407 to access information exchange service 417 on behalf of information management application 411 and information management application 413 respectively. Application platform 405 may communicate with service environment 409 to access information exchange service 419 on behalf of information management application 415. From time to time, service environment 407 and service environment 409 may communicate in furtherance of interaction between information exchange service 417 and information exchange service 419

Examples of application platforms 401, 403, and 405, include, but are not limited to, desktop computers, work stations, laptop computers, notebook computers, tablet computers, mobile phones, personal digital assistances, media devices, gaming devices, and any other physical or virtual computing machine or combinations and variations thereof capable of implementing at least one of a variety of information management applications. Service environment 407 may be any computing system or collection of computing systems capable of implementing an information exchange service 417.

Application platforms 401, 403, and 405 may each be any computing apparatus, system, device, or collections thereof that employ a computing architecture suitable for implementing information management application 411, 413, or 415 respectively. Computing architecture 300 referred to with respect to FIG. 3 is one such representative architecture. Information management applications 411, 413, and 415 may each be any version or variety of an information management application. Examples include but are not limited to locally installed and executed applications, streaming applications, web-based applications that execute at least in part within the context of a browser application, mobile applications, mobile web-based applications that execute at least in part within the context of a mobile browser application, or any other application type, variation, or combination thereof.

Information management applications 411, 413, and 415 may each be embodied in program instructions that, when executed by application platforms 401, 403, and 415 respectively, direct each to operate as described herein for enhanced view process 200 discussed with respect to FIG. 2. The program instructions may take the form of compiled object code, interpreted scripts, or any other suitable form of program instructions that may be executed directly or indirectly by an application platform, as well as any suitable variation or combination thereof. Examples of information management applications include but are not limited to Microsoft® Outlook®, Mozilla Thunderbird/Lightening, Open Xchange, Microsoft® Outlook® Web App, Microsoft® Outlook® Web App for mobile device, Outlook.com®, Gmail, and Microsoft® Outlook® for mobile devices, as well as any other suitable information management application, variation, or combination thereof.

Service environment 407 and service environment 409 may each include any computing apparatus, system, device, or collections thereof that employ a computing architecture suitable for implementing information exchange service 417 and information exchange service 419 respectively. Computing architecture 300 referred to with respect to FIG. 3 is one such representative architecture. Examples include server computers, cloud computing platforms, data centers, and any physical or virtual computing machine, as well as any variation or combination thereof. Examples of information exchange service 417 and information exchange service 419 include but are not limited to Microsoft® Exchange®, Microsoft® O365®, Hotmail®, Outlook.com®, and Gmail, as well as any other information exchange service, combination, or variation thereof capable of operating as described herein.

In operation, any of applications platforms 401, 403, and 405 may communicate from time to time with service environment 407 or service environment 409 over communication network 410 to facilitate the exchange of information between information management applications 411 and 413 and information exchange service 417 and between information management application 415 and information exchange service 419. Service environment 407 and service environment 409 may also communicate over communication network 410 to facilitate the exchange of information.

Communication between any of the elements contemplated in FIG. 4 may occur in accordance with various communication protocols, such as the Internet protocol (IP, IPv4, IPv6, etc.), the transfer control protocol (TCP), and the user datagram protocol (UDP), as well as any other suitable communication protocol, variation, or combination thereof. Communication network 410 may be representative of a network or collection of networks over which the element contemplated in FIG. 4 may exchange information, such as an intranet, the Internet, a local area network, a wide area network, a wireless network, a wired network, or any combination or variation thereof. Communication network 410 may include connections, devices, and communication media, such as metal, glass, air, or any other suitable communication media over which information may be exchanged. The aforementioned communication media, network, connections, protocols, and devices are well known and need not be discussed at length here.

The manner in which information is exchanged may vary. In some implementations, an application may exchange information with a service environment and information exchange service in accordance with various information exchange protocols, such as IMAP (internet message access protocol), POP (post office protocol), SMTP (simple mail transfer protocol), and MAPI (message application programming interface). In other implementations, an application may exchange information with a service environment and information exchange service in accordance with various other information exchange protocols, such as HTTP (hypertext transfer protocol), REST (representational state transfer), or WebSocket, as well as any other suitable information exchange protocol, variation, or combination thereof.

What information is exchanged or what format the information takes may also vary. For example, an application or associated browser (in the case of a browser based application) may receive information formatted in accordance with a variety of information protocols, such as DOM (Document Object Model), HTML (hypertext markup language), CSS (cascading style sheets), HTML5, XML (extensible markup language), Javascript, JSON (Javascript Object Notation), and AJAX (Asynchronous Javascript and XML), as well as any other suitable information protocol, variation, or combination thereof. The information may include data or objects that may be processed for presentation, such as images and text. However, the information may also include scripts or other information that may be interpreted or otherwise processed by the browser or some other application for execution. In other implementations, an application may exchange discrete messages representative of an email, calendar event, or some other item of information formatted in accordance with an information protocol suitable to that application.

FIG. 5 illustrates one exemplary view 501 that may be rendered by one or more of information management applications 411, 413, and 415. In addition, three different scenarios, scenario 591, scenario 593, and scenario 595, are illustrated to demonstrate how view 501 may be scaled based on the form factor of a rendering device. In scenario 591, view 501 is rendered in full and may be representative of a view displayed on a relatively large screen, such as a computer monitor or other suitable device. In scenario 593, view 501 is scaled down relative to its presentation in scenario 591, and may be representative of an application scale experienced on a tablet device or some other device having smaller dimensions. In scenario 595, view 501 is scaled down even more relative to scenario 591 and scenario 593 and may be representative of an application scale experience on a mobile phone or other similar devices. View 501 may include additional features that those disclosed herein and some of the features may be omitted. In addition, view 501 is provided merely for illustrative purposes and not to limit the scope of the present disclosure.

In scenario 591, view 501 includes an information area 511 that may be used to display the name of the application or other suitable information. Information area 511 includes several selectable options that, when selected, launch the presentation of other views associated with other modules. In particular, mail option 512 corresponds to an email module, calendar option 513 corresponds to a calendar module, contacts option 514 corresponds to a contacts module, and tasks option 515 corresponds to a tasks module. Information area 511 also includes an identity option 516 representative of an identity of a user engaged with view 501. View 501 may include additional features or some of the features discussed herein may be omitted.

For exemplary purposes, it is assumed that mail option 512 has been selected and thus view 501 is representative of a view that may be encountered when working with an email module. Accordingly, view 501 includes various panels having various items and other functionality rendered and available for interaction with a user. Navigation panel 521 includes, but is not limited to, various folders that a user may select in order to access their contents, such as an inbox folder 525, a sent folder 527, and a drafts folder 529. Depending upon which folder is selected, its corresponding contents may be displayed in the panel adjacent to navigation panel 521. It is assumed here for exemplary purposes that inbox folder 525 is selected. Accordingly, inbox 531 and its contents are displayed adjacent to navigation panel 521. It may be appreciated that the various panels and their contents could be arranged in a variety of ways and are not limited to just those disclosed herein.

Content panel 539 provides a more detailed view of a selected item. For example, content panel includes content associated with email 536, assumed for exemplary purposes to have been selected by a user for reading, editing, or the like. Other aspects may be included in content panel 539, such as in-line reply capabilities, that are well known and need not be discussed at length here.

In scenario 593, information area 511 is considerably smaller relative to its size in scenario 591. In addition, navigation panel 521 is absent. It may be appreciated that other configurations are possible that would result in a smaller scale for view 501 and may be considered within the scope of the present disclosure. For example, other elements may be absent rather than, or in addition to, navigation panel 521.

In scenario 595, content panel 539 is absent, in addition to navigation panel 521, and thus the scale of view 501 is considerably smaller than in scenario 591 or 593. It may be appreciated that other configurations are possible that would result in a smaller scale and may be considered within the scope of the present disclosure, such as by eliminating other elements in place of or in addition to navigation panel 521 and content panel 539.

FIG. 6 illustrates various scenarios (scenario 693 and scenario 695) that again demonstrate how an information management application may scale to fit the display dimensions of a given device. Scenario 693 and scenario 695 illustrate the same view 501 as in FIG. 5, except that it is assumed here for exemplary purposes that calendar option 513 has been selected. In scenario 693, view 501 may be representative of a view displayed on a variety of screens, such as a computer monitor, tablet device, or the like. In scenario 695, view 501 is scaled down relative to scenario 693 and may be representative of an application scale experience on a mobile phone or other similar devices.

When selected and active, the calendar module in scenario 691 includes but is not limited to a calendar panel 545. Calendar panel 545 includes a calendar perspective 547 on a month to which a user navigated. Calendar perspective 547 includes a grid and various days within the grid. It is assumed here for exemplary purposes that a secondary indication of interest 549 has been made and a secondary event perspective 551 presented in response thereto. For example, the user may touch, click on, hover over, or otherwise select the event. In this scenario, event “S” is selected and its event details displayed in a secondary event perspective 551. The event details include, for example, a subject for a meeting, a room for the meeting, a list of invitees who have accepted an invitation, and the like. The secondary event perspective 551 also includes a subset of controls, control 553, control 555, and control 557, that might be available via a primary event perspective.

Scenario 695 illustrates a scaled down version of view 501. In this scenario, calendar perspective 547 is slightly compressed relative to its previous presentation. Secondary event perspective 551 appears largely the same, although it may be appreciated that changes may also be made with respect to it in order to conform to device dimensions.

FIG. 7 illustrates various scenarios (scenario 793 and scenario 795) associated with view 501 in which the controls included in secondary event perspective 551 are determined dynamically. In scenario 793, view 501 includes secondary event perspective 551 populated with three controls, control 553, control 555, and control 557, representative of those that may be presented to an organizer or originator of an event. For example, the person that sent an invite may be considered the originator of the event. Accordingly, the subset of controls (control 553, control 555, and control 557) in scenario 793 include a cancel control, an invite control, and a modify control. In scenario 795, view 501 includes secondary event perspective 551 populated with only two controls, control 554 and control 556, representative of those that may be presented to a recipient of an invitation. In scenario 795, control 554 is a rejection control that enables a user to reject an invitation and control 556 is an acceptance control that enables a user to accept an invitation.

In operation, which controls are selected for inclusion in a secondary event perspective or peek on an event are determined based on a user perspective associated with the indication of interest 549 made with respect to the event. The user perspective could be, for example, the identity of a user, a role of the user with respect to the event, or any other type of user perspective. In one example, the user perspective relates to whether or not the user is the originator of an event or invitation or the recipient of the invitation. Depending upon that user perspective, the controls surfaced within a peek on an event can vary.

The various controls correspond to various features provided by an information management application with respect to the event. A cancel control enables an organizer to cancel an event. A modify control or an edit control enables an organizer to edit and change event details. An invite or join control enables an organizer to invite additional people to participate in the event. An acceptance control and a rejection control enables a user to accept or reject an invitation. These controls are representative of some controls that may be included in a subset of controls provided in a primary perspective on an event. Other controls from which the subset may be drawn include a forward control for forwarding an invitation to other users, a suggest control for suggesting alternative times for an event, contact controls for interacting with other contacts included in an invitation, as well as any other type of control.

FIG. 8 illustrates another scenario 893 in which secondary event perspective 551 is expanded to include another specific event. In operation, a user makes a gesture 550, such as a zoom gesture, with respect to secondary event perspective 551. The gesture 550 expands secondary event perspective 551 which is then populated with event details for another specific event. Which event is included in the expanded peek could be determined in a variety of ways, such as by including the next event most proximate in time to the event already detailed in secondary event perspective 551. In this manner, a user may peek in on more than one event simultaneously and have access to a subset of controls for each event.

While scenario 893 demonstrates an expansion in the vertical direction, it may be appreciated that such an expansion could occur in any direction, such as horizontally. In such a scenario an expansion gesture could be made in the horizontal direction, expanding secondary event perspective 551 to the left and right. As secondary event perspective 551 expands, or once it expands to a sufficient size, it can be populated with event details for at least one other event, possibly arranged side by side with another event perspective. In yet another scenario, secondary event perspective 551 could be expanded diagonally.

In FIG. 9, scenario 993 illustrates how a user may navigate between events from within an event peek. In scenario 993, secondary event perspective 551 initially includes event details for event “S.” A gesture 560, such as a swipe gesture, moves those event details out of the secondary event perspective 551 and drags in event details for another event. In this example, the details for event “S” are removed and substituted with the event details for event “R.” Which event is substituted for the initial event could be determined in a variety of ways, such as by including the next event most proximate in time to the event already detailed in secondary event perspective 551. In this manner, a user may navigate between events from within an event peek.

The discussion of FIGS. 1-9 for purposes of clarity may have referred to various elements included in information management applications, such as days, calendar perspectives, and panels, as well as other elements, without referring to those elements as graphical representations of the same or in some other manner indicative of their technical nature. However, it may be appreciated that such terms and phrases may be used interchangeably and such usage or lack thereof does not limit the scope of the present disclosure. To the contrary, the present disclosure may be considered to encompass a wide variety of well-known techniques for graphically representing the various elements included in the various implementations discussed throughout. Thus, at least a portion of these and other elements illustrated in FIGS. 1-9 may be embodied in graphical representations of the elements. For example, a day, perspective, or panel referred to as such with respect to the Figures may be considered a graphical representation of the same.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable storage media having program instructions stored therein for facilitating enhanced calendar views that, when executed by a computing system, direct the computing system to at least:
present a perspective on a calendar comprising a plurality of calendar units and a plurality of events scheduled in association with the plurality of calendar units;
in response to a primary indication of interest associated with a specific event of the plurality of events, present a primary perspective on the specific event comprising event details for the specific event and a plurality of event controls; and
in response to a secondary indication of interest associated with the specific event of the plurality of events, present a secondary perspective on the specific event that comprises a different perspective on the specific event relative to the primary perspective.

2. The one or more computer readable storage media of claim 1 wherein the specific event comprises an invitation and wherein the secondary perspective comprises at least a portion of the event details and only a subset of the plurality of event controls, and wherein each control of the plurality of event controls corresponds to a different one of a plurality of features.

3. The one or more computer readable storage media of claim 2 wherein the subset of the plurality of event controls comprises an acceptance control for accepting the invitation and a rejection control for rejecting the invitation.

4. The one or more computer readable storage media of claim 2 wherein the subset of the plurality of event controls comprises a modify control for modifying the invitation and a cancel control for canceling the invitation.

5. The one or more computer readable storage media of claim 2 wherein the secondary perspective comprises a peek on the specific event.

6. The one or more computer readable storage media of claim 1 wherein the perspective comprises a monthly perspective and wherein each of the plurality of calendar units comprises a different day in a month associated with the monthly perspective.

7. The one or more computer readable storage media of claim 1 wherein the secondary indication of interest comprises a hover action with respect to the specific event and wherein the primary indication of interest comprises an action other than a hover action.

8. The one or more computer readable storage media of claim 1 wherein the secondary indication of interest comprises a single instance of an action made with respect to the specific event and wherein the primary indication of interest comprises a double instance of the action made with respect to the specific event.

9. A method for facilitating enhanced calendar views comprising:
presenting a perspective on a calendar comprising a plurality of calendar units and a plurality of events scheduled in association with the plurality of calendar units;
in response to a primary indication of interest associated with a specific event of the plurality of events, presenting a primary perspective on the specific event comprising event details for the specific event and a plurality of event controls; and
in response to a secondary indication of interest associated with the specific event of the plurality of events, presenting a secondary perspective on the specific event that comprises a different perspective on the specific event relative to the primary perspective.

10. The method of claim 9 wherein the specific event comprises an invitation and wherein the secondary perspective comprises at least a portion of the event details and only a subset of the plurality of event controls, and wherein each control of the plurality of event controls corresponds to a different one of a plurality of features.

11. The method of claim 10 wherein the subset of the plurality of event controls comprises an acceptance control for accepting the invitation and a rejection control for rejecting the invitation.

12. The method of claim 10 wherein the subset of the plurality of event controls comprises a modify control for modifying the invitation and a cancel control for canceling the invitation.

13. The method of claim 10 wherein the secondary perspective comprises a peek on the specific event.

14. The method of claim 9 wherein the perspective comprises a monthly perspective and wherein each of the plurality of calendar units comprises a different day in a month associated with the monthly perspective.

15. The method of claim 9 wherein the secondary indication of interest comprises a hover action with respect to the specific event and wherein the primary indication of interest comprises an action other than a hover action.

16. The method of claim 9 wherein the secondary indication of interest comprises a single instance of an action made with respect to the specific event and wherein the primary indication of interest comprises a double instance of the action made with respect to the specific event.

17. A computing apparatus comprising:
a computer readable storage media; and
program instructions stored on the computer readable storage media that, when executed by a processing system, direct the processing system to at least:
initiate presentation of a monthly perspective of a calendar comprising a plurality of days and a plurality of events scheduled in association with the plurality of days;
in response to an indication of interest associated a specific event of the plurality of events, initiate presentation of a peek on the specific event comprising at least a portion of a plurality of event details associated with the specific event and a subset of a plurality of event controls associated with the specific event.

18. The computing apparatus of claim 17 wherein the program instructions further direct the processing system to identify which of the plurality of controls to include in the peek based at least on a user perspective associated with the indication of interest.

19. The computing apparatus of claim 17 wherein the program instructions further direct the processing system to, in response to an expansion gesture, initiate an expansion of the peek to another specific event.

20. The computing apparatus of claim 17 further comprising the processing system configured to execute the program instructions, wherein the program instructions further direct the processing system to initiate a substitution of the specific event in the peek with another specific event in response to a swipe gesture.
